(19) United States
(12) Patent Application Publication
(10) Pub. No.: US 2011/0300429 A1
(43) Pub. Date: Dec. 8, 2011

(54) Automotive ballast battery

(76) Inventor: Edward Milton MsWhorter, Citrus Heights, CA (US)

(21) Appl. No.: 12/802,436

(22) Filed: Jun. 8, 2010

(51) Int. Cl. H01M 4/00

(52) U.S. Cl. 429/128

(57) ABSTRACT

The invention is a nickel-iron alkaline storage battery used to process gaseous charged ionic emissions from a capacitor tuyere exhaust stream produced by an Electrolytic Diffusion Fuel Cell. The said ionic emissions are used in a Rapid Charge Transportation Battery pack of an electric vehicle to alleviate cathode electrode passivity during periods of heavy charging while the vehicle is in motion.

### CROSS REFERENCES

Ref. 1 U.S. application Ser. No. 12/378,425 Filed Feb. 17, 2009

Ref. 2 U.S. Pat. No. 6,831,825 Issue Dec. 14, 2004

Ref. 3 U.S. application Ser. No. 12/590,814 Filed Nov. 16, 2009

Ref. 4 U.S. application Ser. No. 12/005,093 Filed Dec. 26, 2007

Ref. 5 U.S. Pat. No. 7,713,400 Issue May 11, 2010

Ref. 6 U.S. Pat. No. 7,288,335 Issue Oct. 30, 2007

### BACKGROUND OF THE INVENTION

The invention is a 1.2 volt nickel-iron alkaline storage battery hereinafter called a Ballast Battery. The Ballast Battery is used in electrical vehicle circuit design to reduce the heating anomaly occurring at the surface of the cathode electrode interface with the battery electrolyte during deep-cycle recharging. The design is predicated on the hypothetical assumption that the heating anomaly is caused by electron momentum losses in passing from electrode metal class-1 electrical conduction resistance into higher electrical resistance class-2 ionic fluid electrolyte conduction.

Free electrons transiting the electrode metal class-1 conductor surface into the electrolyte class-2 ionic fluid conductor medium during battery charging lose momentum and this loss in kinetic energy is conserved as actinic heating energy radiating across the circuit interface into the electrolyte. The proportional thermal increase (Q) across the said interface with increased circuit resistance (R) and with exponential increases with charging current (I²) in accordance with Joules Law (Q=I²R) and with subsequent mass (m) heating and changes in temperature (ΔT) relative to the interface substance specific heat (α) such that (Q=αmΔT).

With continued charging and electron passage through the thermally stressed area the temperature exceeds the boiling point of the water component of the electrolyte and steam is generated. Electron passage through the ebullition zone results in electrolysis of the thermally stressed water molecule resulting in the severance of the hydrogen to oxygen bond releasing hydrogen gas further expanding the ebullition zone of the heat transfer coefficient. Poor thermal conduction through the heat transfer boundary between the electrode and electrolyte during high rates of charging can damage the cell electrode by overheating which displaces the surface reactive chemical coatings of the electrode and thereby weakens the cell and limits its effective capacity on subsequent discharge cycles. The damaged cell thermal interface results in an increase in the electrolytic generation of hydrogen. The coproduction of negatively charged electrons is released in the process at a faster rate than the oxygen component of the water molecule hydroxyl ion can carry them away resulting in surface passivity and current flow is impeded.

The Ballast Battery design as previously stated is predicated on the hypothetical assumption that the heating anomaly is caused by electron momentum losses incurred during deceleration in passing from class-1 metal electrode conduction to a higher electrical resistance slower conducting class-2 ionic fluid conduction. More profoundly the loss in electron momentum results in the slowing of electrons in advance of the faster moving electrons shortening the space between them, a condition called compaction. The interval between electrons is shortened but the electrons do not contact. Electrons have mass and axial spin and also a spherical negatively charged field which also spins in concert with the mass. As the free electrons transition from the metal electrode class-1 conductor into the higher electrical resistivity of the class-2 electrolyte fluid ionic conductor the space between the electrons is shortened, resulting in said electron compaction. Electron compaction causes the negatively charged fields of the said spinning electrons to be compressed into a distorted spheroidal form. Because the distorted electron fields are like-charged and also spin and are asymmetrical during compression their polar repulsion results in actinic heat radiation.

Electron compaction and subsequent field compression is avoided in the present invention by reversing the manner of charging the battery circuit. The battery electrodes are partially recharged by a class-2 gaseous fluid conductor by an electrolytic diffusion fuel call described in Ref. 3.

The Ballast Battery is used in series electrical circuit with an electrical vehicle battery pack comprised of alkaline “Rapid Charge Transportation Batteries” described in (Ref. 1). The charged ionic gaseous emission of the “Electrolytic Diffusion Fuel Cell” of Ref. 3 passes through a “capacitor tuyere” described in Ref. 4 where free electrons are stripped from the said emissions and statically deposited on a plurality of toroidal electrolytic capacitors also described in Ref. 4. The remaining now positively charged gaseous emission flow exits the capacitor tuyere and passes into the central anode tubular passage of the Ballast Battery. The said positively charged ionic flow is discharged from the said anode tubular passage of the Ballast Battery where the said flow is distributed into the ionic capacitor charging circuits of the “Rapid Charge Transportation Batteries” (Ref. 1) gas circuit and passes out of the said gas circuit into a holding tank for spent liquid electrolyte. The gaseous component of the said spent electrolyte, comprised principally of nitrogen and oxygen, is vented into the ambient atmosphere.

The anode and cathode plates are constructed as a plurality of circular disc plates horizontally positioned within a steel-asphalt extended rubber cylindrical encasement. The aqueous solution of the 21% KOH electrolyte does not dissolve or disintegrate the active materials of the electrodes such that residue will not be deposited on the horizontal surfaces of the discs. The plates of the Ref. 1 batteries are positioned vertically in the normal method of alkaline storage batteries. Although the anode and cathode plates of the Ballast Battery are circular and are positioned horizontally within the said cylindrical encasement as compared to the vertical positioning of the plates of Ref. 1 these features though unique are not claimed as novelty in the application. The novelty of the Ballast Battery structural design to be claimed is the vertical duct which carries the gaseous diffusion discharge flow from the Electrolytic Diffusion Fuel Cell through the axial center of the Ballast Battery. As the said gaseous diffusion discharge flow begins to cool the evaporated water component condenses and falls by gravity to the bottom of the duct and is separated from the gaseous component of the flow in passing through a diffusion manifold. The said gaseous component which is positively charged is passed through the battery ionic capacitors of Ref. 1 batteries alleviating passivity of the cathode electrodes and the collected condensed water component is directed into a spent electrolyte tank as a value-added product to be further processed.

The 21% KOH electrolyte is the ichor of the alkaline storage battery, it acts as a transfer medium carrying vital oxygen to the positive electrode during discharge and depositing it at the negative electrode. On recharge the reaction is reversed and the positive and negative reacting materials revert to their original charged state at each electrode. The reversible chemical reaction occurring during discharge and recharging produce intermediate transitory compounds but the final result in each instant is the transfer of oxygen between the positive nickel hydroxide Ni(OH₂) cathode and the anode negative iron hydroxide Fe(OH)₂ produced in reverse back again to its reduced (Fe) beginning condition. Neglecting the intermediate reactions, the reversal end formula in each instance is given by the following counter chemical reactions.

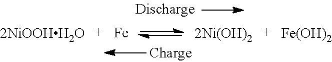

No reaction byproducts are formed in the reversible chemical reactions.

It is estimated by U.S. government agencies (EPA) that 88% of a 100 horsepower gasoline engine is lost in waste heat and system frition such that only about 12 hp is available for traction. For an electric vehicle to be competitive in horsepower a 120 volt battery pack must store a minimum of 74.58 amps for each hour of operation (74.58 amp-hrs). For an extended duration and operating range of 6 hours the system must be capable of storing 447.5 amp-hrs. This material is produced in Ref. 5 and the method of releasing it is described in Ref. 6.

The positively charged ionic emissions through the center tube duct of the Ballast Battery and through the ionic capacitors of the “Rapid Charge Transportation Battery” of Ref. 1 absorb the stable passivity layer at the cathode metal surface and alleviate heating in the electrical vehicle battery pack.

### SUMMARY OF THE INVENTION

The Ballast Battery provides a means of charging automobile batteries while the vehicle is in motion without excessive heating and ebullition at the cathode/electrolyte interface. The heating anomaly is caused by free electron momentum loss during heavy current passage from the electrode metal class-1 conductor into a higher electrical resistance class-2 fluid ionic conductor during charging. It is an object of the invention to reverse the system charging scheme by partially charging the cathode class-1 metal conductor of the electric vehicle battery pack from the charged ionic gaseous emissions from an Electrolytic Diffusion Fuel Cell (Ref. 3). The said charged ionic emissions alleviate the problem of surface passivity at the cathode of the batteries in the electric vehicle battery pack.

It is another object of the invention to construct a ballast battery which has a plurality of anode and cathode electrodes in which each said electrode is constructed as a plurality of large disc plate surfaces. The said anode plate discs are positioned in electrical contact and supported by attachment to the inner metallic surface of the Ballast Battery containment cylinder. The cathode electrode disc plates are positioned between the said anode disc plate electrodes and are mounted on a central gaseous diffusion steel ducting that passes through the axial center of the Ballast Battery. All of the said cathode discs are in electrical contact in being mounted on the said gaseous diffusion steel ducting carrying a gaseous diffusion emission from Ref. 3. Gaseous diffusion exiting the said central ducting is ducted into the main battery pack cathode ionic capacitors of Ref. 1 to alleviate cathode passivity.

### BRIEF DESCRIPTION OF THE DRAWINGS

Drawings of the proprietary elements of the Automotive Ballast Battery are presented.

FIG. 1a is a plan view of the anode disc plate electrode—two are required to form the top and bottom.

FIG. 1b is a section view of the said anode disc plates electrode of FIG. 1 showing how one plate is inverted to form the bottom half of the two-part electrode.

FIG. 2a is a plan view of the cathode disc plate electrode.

FIG. 2b is a section view of the cathode disc plate electrode.

FIG. 3 is a section view of the anode electrode of FIG. 1b assembled on each side of the cathode electrode of FIG. 2b.

FIG. 4 is a section view of the Ballast Battery assembly. All of the elements which constitute the Claims are presented in this drawing.

FIG. 5 is a block diagram of the Ballast Battery electric circuit in an Electrolytic Diffusion Fuel Cell electric vehicle circuit.

### DETAILED DESCRIPTION OF THE INVENTION

FIG. 1a is a top view of the Ballast Battery anode disc plate 1. Anode disc plate 1 has a centrally located circular opening hole 2 for passage of gaseous diffusion ducted exhaust vapor flow from an Electrolytic Diffusion Fuel Cell of Ref. 3. Flange 3 encircles the outer perimeter of anode disc plate 1. Flange 3 is used to fixedly attach anode disc plate 1 to the inner surfaces of the Ballast Battery steel containment cylinder 9. Two anode disc plate 1's are required to form the anode electrode.

FIG. 1b is a drawing showing two sectional views of FIG. 1a anode disc plate 1. The lower section is an inverted view such that the two interior surfaces facing each other are mirror images. A concentric channel 4 is shown as an indented channel 4 encircling hole 2. Channel 4 contains a reduced iron (Fe) coating as the active cell reagent. The top and bottom anode disc plate 1 channels 4 are shown facing each other. Gaseous diffusion ducting leading from an Electrolytic Diffusion Fuel Cell Ref. 3 passes through hole 2 but does not contact anode disc plate 1 through an intervening KOH electrolyte.

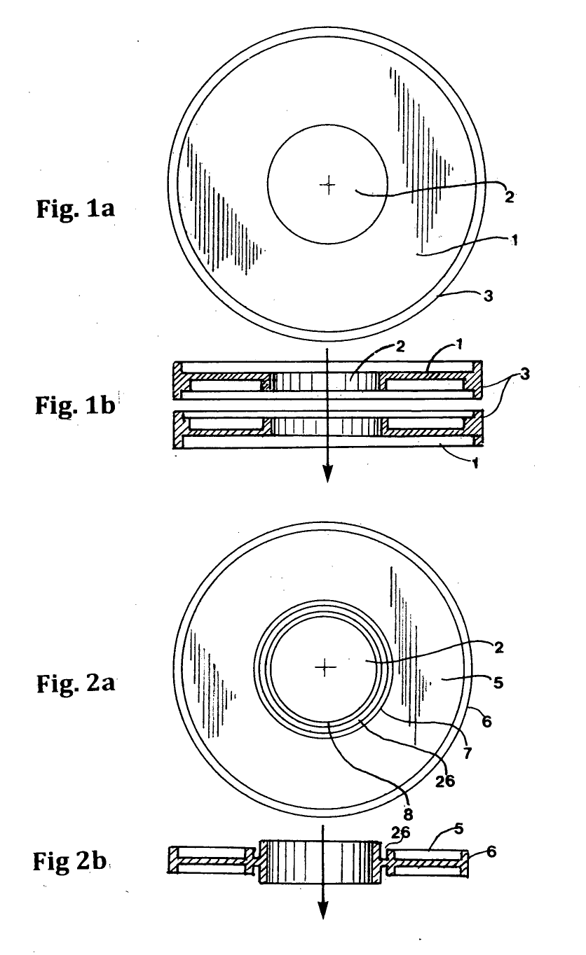

FIG. 2a is a top view of the cathode disc plate 5. Outer flange 6 encircles the outer perimeter of cathode disc plate 5. Inner flange 7 encircles diffusion tubular duct 8 and is in electrical contact with said tubular duct 8.

FIG. 2b The elements of the bottom surfaces of cathode disc plate 5 are the same as the numbered top surface elements.

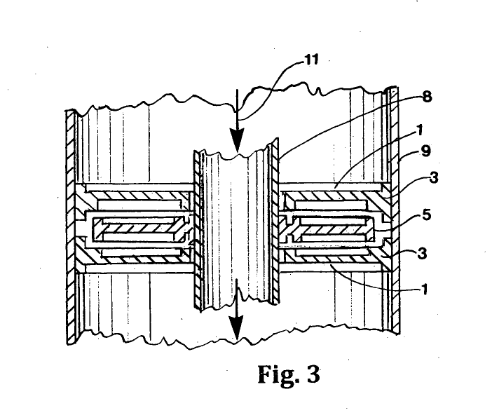

FIG. 3 is an assembled cell comprising the two halves of anode disc plate 1 assembled on each side of cathode disc plate 5. Anode disc plates 1 are shown fixedly attached to battery steel containment cylinder 9. Cathode disc plate 5 is shown between the two halves of the anode disc plate 1 and is fixedly attached to gaseous diffusion duct 8. The directing arrows indicate the downward vertical flow through said duct 8. Anode disc plate 1 is insulated internally from cathode disc plate 5 by hard rubber separator rings and gland bushings and rubber pins (not shown).

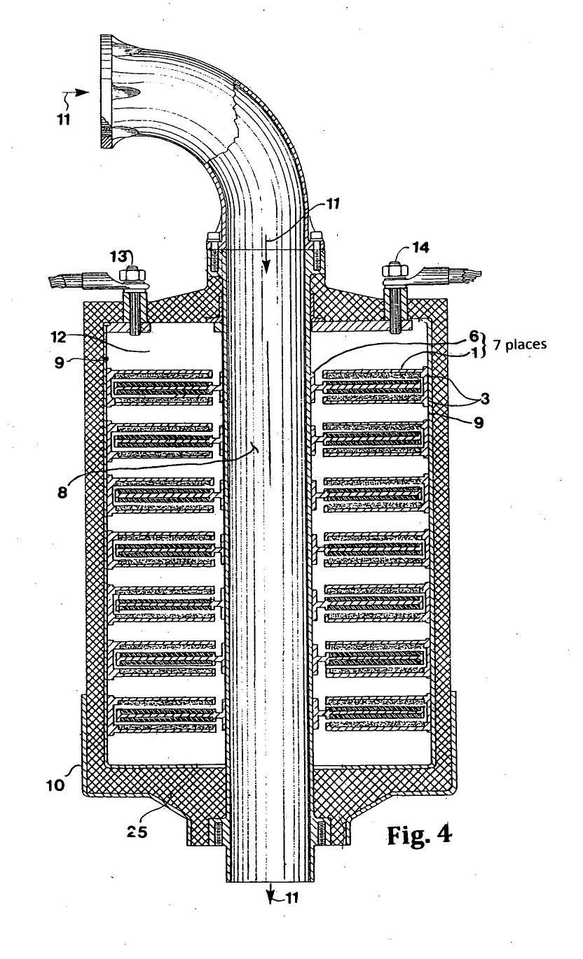

FIG. 4 is a section view of the assembled Ballast Battery showing a plurality of anode disc plates 1 (shown as 7 places) fixedly attached to the inner surfaces of the steel containment cylinder 9 by flanges 3. Positioned between each pair of said anode disc plates 1 is cathode disc plate 5 fixedly attached to duct 8. Seven paired anode disc plates 1 and seven cathode plates 5 are shown. The said seven cathode plates 5 attached to duct 8 and are prevented from contacting anode disc plates 1 by rubber separators and bushings not shown. A thick wall structure of asphalt extended rubber similar to that used in lead-acid storage batterie's shown in double cross-hatch forms the outer structure 10 of the Ballast Battery. Gaseous diffusion flow 11 from an electrolytic diffusion fuel cell of Ref. 3 enters duct 8 passing through duct 8 and exits duct 8. The anode and cathode disc plates 1 and 5 respectively are submerged in a 21% KOH electrolyte 12. The anode pole fastener 13 and cathode pole fastener 14 are positioned on the top surfaces of the Ballast Battery each shown as fixedly attached to the cylinder 9 and duct 8 respectively.

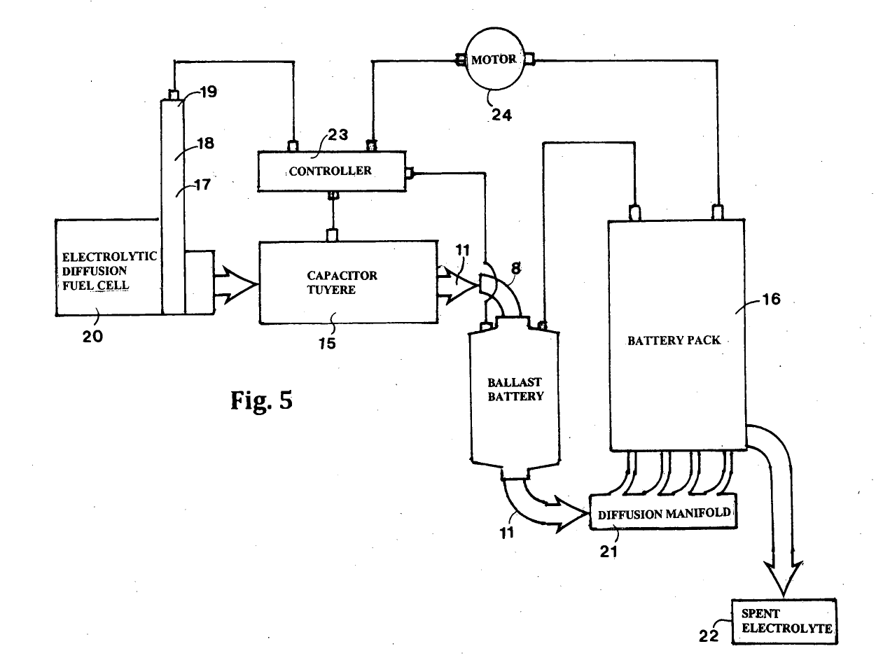

Turning now to FIG. 5 which is a block diagram of an electric vehicle propulsion circuit showing the placement of the Ballast Battery between a capacitor tuyere 15 and battery pack 16. Nodular electrolytic flocculant fuel 17 (not shown) of Ref. 5 is placed on alkaline electrode tape 18 (not shown) and fed into fuel magazine 19 of Electrolytic Diffusion Fuel Cell 20 described in Ref. 2. The said Electrolytic Diffusion Fuel Cell 20 discharges electrons into a capacitor tuyere 15 described in Ref. 4. A positive charged diffusion flow 11 is discharged from the said capacitor tuyere 15 and passes into Ballast Battery duct 8. The gaseous diffusion flow 11 passes out of duct 8 and passes into diffusion gas manifold 21 where condensed water vapor is condensed from the said flow 11 and placed in a spent electrolyte tank 22. The electrical circuitry through the controller 23 and motor load 24 is typical of a single battery pack 16 system. When two battery packs are used one is being charged and the operating system is driving the motor. Although the electric vehicle propulsion circuit shown in FIG. 5 is comprised of many component parts only the numbered elements of the Ballast Battery presented as FIG. 4 are claimed as this invention.

LIST OF ELEMENTS

| | |
|---|---|
| 1. | anode disc plate |
| 2. | hole |
| 3. | flange |
| 4. | channel |
| 5. | cathode disc plate |
| 6. | outer flange |
| 7. | inner flange |
| 8. | duct |
| 9. | containment cylinder |
| 10. | outer structure |
| 11. | gaseous diffusion flow |
| 12. | Electrolyte |
| 13. | anode pole fastener |
| 14. | cathode pole fastener |
| 15. | capacity tuyere |
| 16. | battery pack |
| 17. | nodular electrolytic fuel |
| 18. | alkaline electrode tape |
| 19. | fuel magazine |
| 20. | electrolytic diffusion fuel cell |
| 21. | diffusion gas manifold |
| 22. | spent electrolyte tank |
| 23. | controller |
| 24. | motor |
| 25. | rubber encasement |
| 26. | space |

What is claimed is:

1. An alkaline storage battery comprising paired electrodes of finely divided nickel (Ni) metal and nickel peroxide (NiO₂) cathode reactant and a coating of iron (Fe) anode-reactant, both said electrodes emersed in a caustic (KOH) electrolyte, said anode and cathode reactants fixed on the surfaces of steel circular disc plates forming electrodes, said anodic disc plates positioned on each side of said cathode disc plate, said anode disc plates and said cathode disc plates having concentric holes around each said disc center, a vertically positioned tubular duct passing through said holes, said cathode disc plate electrodes fixedly attached to said duct, a steel cylinder encircling said anode and cathode disc plate electrodes and said duct, said anode disc plate electrode fixedly attached to said steel cylinder, electric pole fasteners attached at the upper end of said tubular duct and said steel cylinder for conducting current from said Ballast Battery said Ballast Battery being encased in a rubber container encasement.
